(19) United States
(12) Patent Application Publication
(10) Pub. No.: US 2007/0061459 A1
(43) Pub. Date: Mar. 15, 2007

(54) Internet content filtering

(75) Inventors: Aaron Culbreth, Bellevue, WA (US); Akiko Maruyama, Redmond, WA (US); Brian L. Trenbeath, Redmond, WA (US); Jordan L. Correa, Lynnwood, WA (US); Keumars A. Ahdieh, Lake Stevens, WA (US); Peter M. Wiest, Issaquah, WA (US); Roger H. Wynn, Redmond, WA (US); Stan D. Pennington, Newcastle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/326,284

(22) Filed: Jan. 4, 2006

Related U.S. Application Data
(60) Provisional application No. 60/716,062, filed on Sep. 12, 2005.

(51) Int. Cl. G06F 15/173

(52) U.S. Cl. 709/225

(57) ABSTRACT

Various internet content filtering mechanisms are disclosed. One such mechanism is a filtering service that uses a filter stack and at least two caches. The filter stack can access these caches during its execution of objects. One of the caches could be a cross-user cache that contains information relevant for internet content to a particular user, but this information could be also used by other users. The other cache could be a cross-application cache that contains information relevant for particular applications, but this information could also be used by other applications. The filtering service can be nicely integrated in an operating system to provide a centralized framework for the filtering of internet content.

### CROSS-REFERENCE TO RELATED APPLICATIONS

This application claims benefit to application Ser. No. 60/716,062, filed September 12, 2005, titled “Internet Content Filtering”. This application is also related to application Ser. No. 11/266,143, filed Nov. 3, 2005, titled “Compliance Interface For Compliant Applications; and application Ser. No. 60/716,294, filed Sep. 12, 2005, titled “Protocol-Level Filtering”, and its non-provisional counterpart bearing the same title, application Ser. No. ______ (attorney docket number MSFT 5443/314366.02).

### BACKGROUND

Efficient and robust internet content filtering has long been a desirable and sought-after feature. This is true not only for controlling the content that a user is exposed to on the internet, but also for recording that activity and allowing restrictions to be overridden as needed. Filtering needs to be customizable to the needs of limited users and easily administrable by the people in charge of applying the filters, such as administrative users, for the limited user being filtered. Naturally, these filters are expected to act seamlessly with the system, be enforced broadly across the system, and actions taken by them need to be easily discoverable by the limited users, so that things don't seem to break for unknown reasons.

There are a number of systems available today that perform internet content filtering with varying degrees of success. Some only work within a particular web browsing client application, while others do function across multiple internet applications, but have major drawbacks in terms of compatibility and interoperability with the operating system and its components, such as firewalls. Some parties provide only simple client post-filtering that is not easily updatable. It would therefore be desirable to address many of the drawbacks of current filtering systems, and provide tight integration with an operating system running on a computing system, in order to allow not only broad enforcement but to give great flexibility and discoverability.

In one specific but not limiting scenario, it would also be desirable to provide a framework that will enable parents to restrict the activities of their children (including the internet content that they will be exposed to). While this type of framework is targeted at protecting kids, the same technology could be applied in other situations as well (perhaps for elderly parents, business environments, or even self-filtering).

### SUMMARY

Various mechanisms are disclosed for providing internet content filtering. For example, a filtering service is provided that may have a first cache and a second cache, where the first cache has cross-user resources and the second cache has cross-application resources that are used to efficiently perform content filtering. Thus, in one aspect, a filter stack is provided and this filter stack is configured to access at least one of these caches. Such accessing of caches obviates the need to obtain these resources from an external computing environment, thus improving the overall operation of a computing system running the filtering service.

By way of example only and not limitation, the filtering service may receive a request for making a judgment regarding a stream of content, that is, whether the stream should be allowed to pass into or out of the computing system. Upon such a request, the filtering service may process the request using the filter stack, where the filter stack is configured to execute typical computing objects. Lastly, the filter stack may access at least one of the caches during the execution of the objects. This may result in resources used for one user or for one application being leveraged and used for another user or another application.

It should be noted, that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. The following figures are included:

FIG. 1 illustrates a content filtering architecture for one exemplary implementation of the presently disclosed subject matter;

FIG. 2 provides a detailed illustration of an aspect of the filtering service that is at the center of the content filtering architecture of FIG. 1;

FIG. 3A illustrates in block diagram form a typical execution path for the filter stack;

FIG. 3B continues the illustration began in FIG. 3A;

FIG. 4 illustrates a parental controls interface, which is configured to provide an individual access to the setting of web content filtering;

FIG. 5 illustrates what happens when a user attempts to access a URL that has been blocked;

FIG. 6 illustrates that the filtering service can make judgments not only whether an entire URL should be blocked, but rather which portions of an associated website should be blocked;

FIG. 7 illustrates how parental controls may be set up by some administrator or parent;

FIG. 8 illustrates in block diagram form an exemplary implementation of one aspect of the presently disclosed subject matter; and

FIG. 9 illustrates that the filtering service could be implemented in a variety of computing environments.

### DETAILED DESCRIPTION

Overview

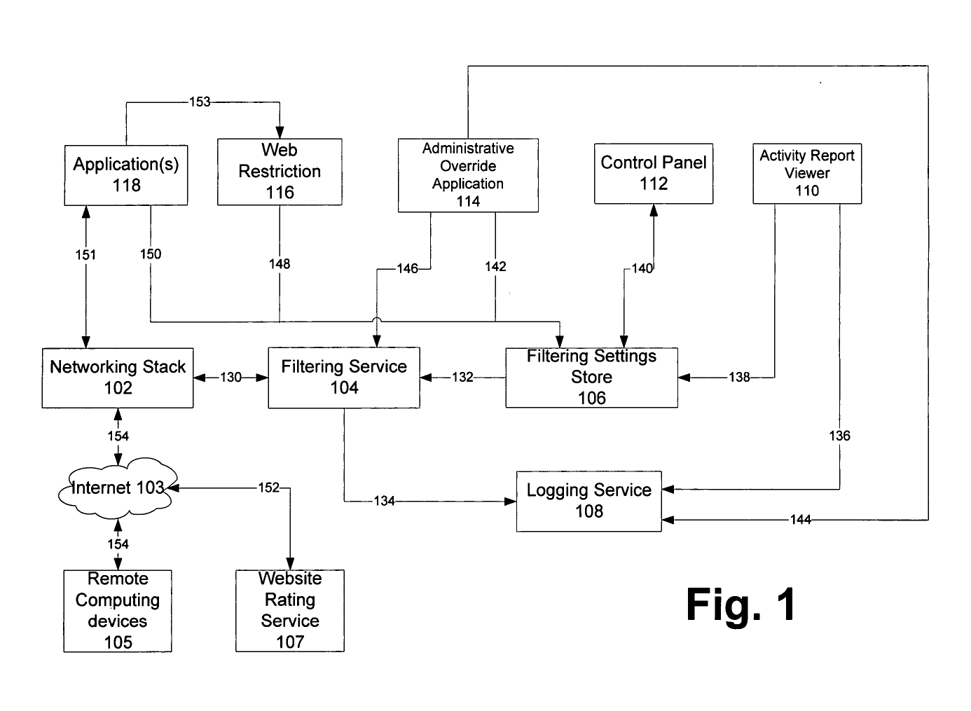

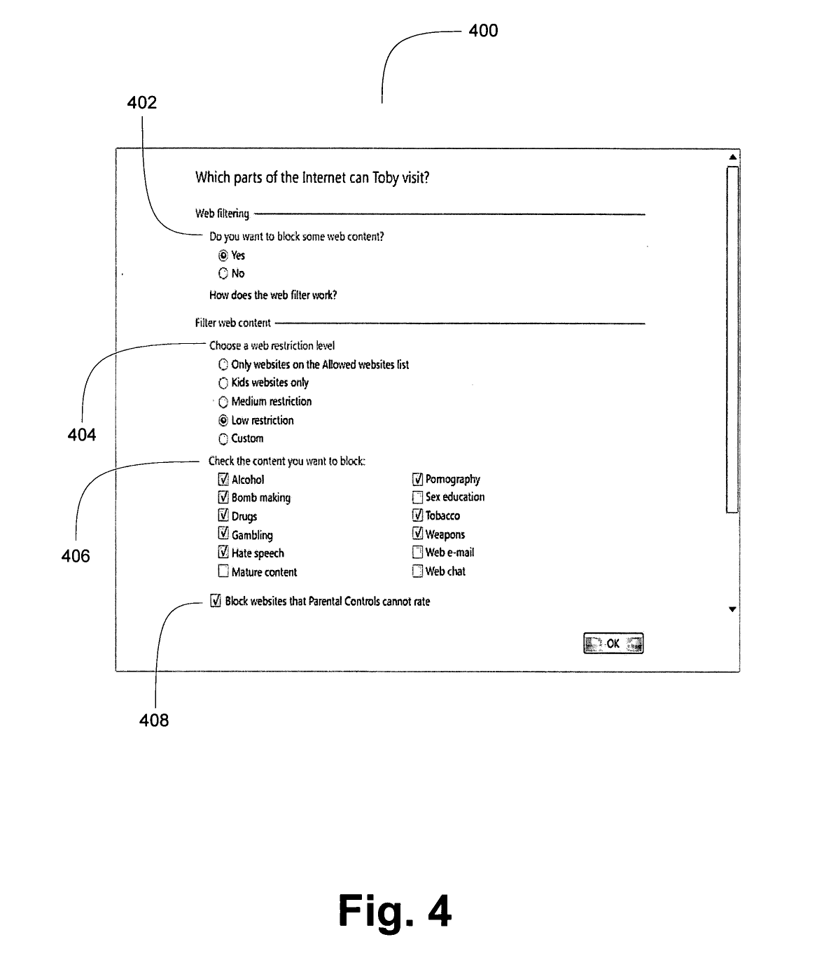

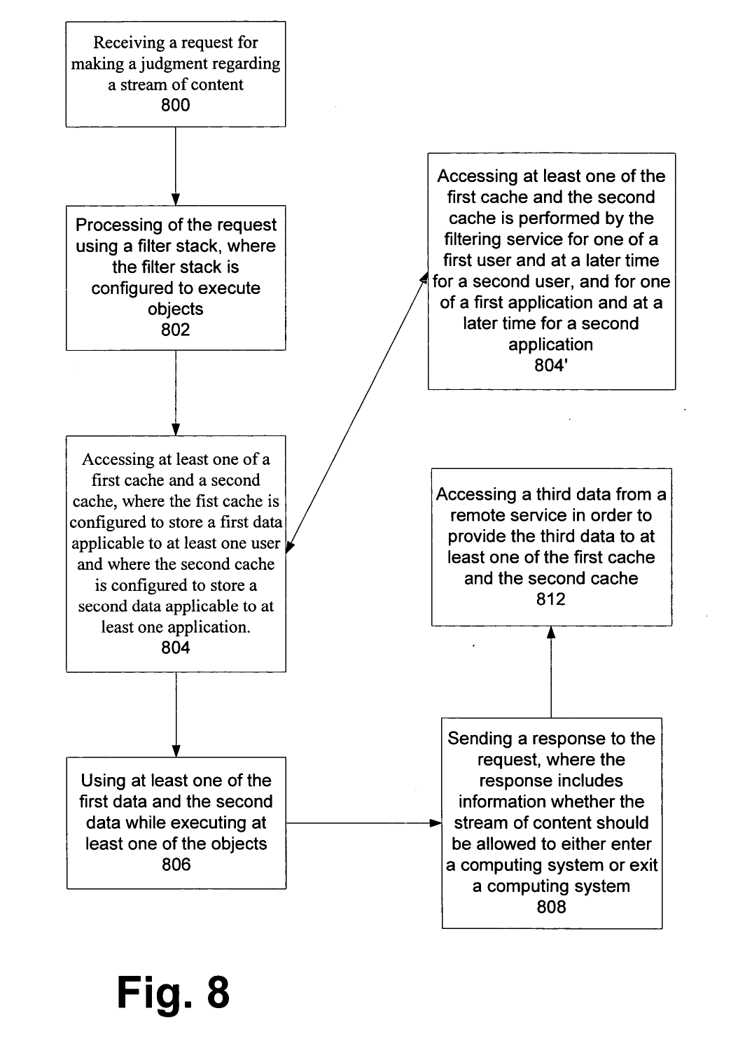

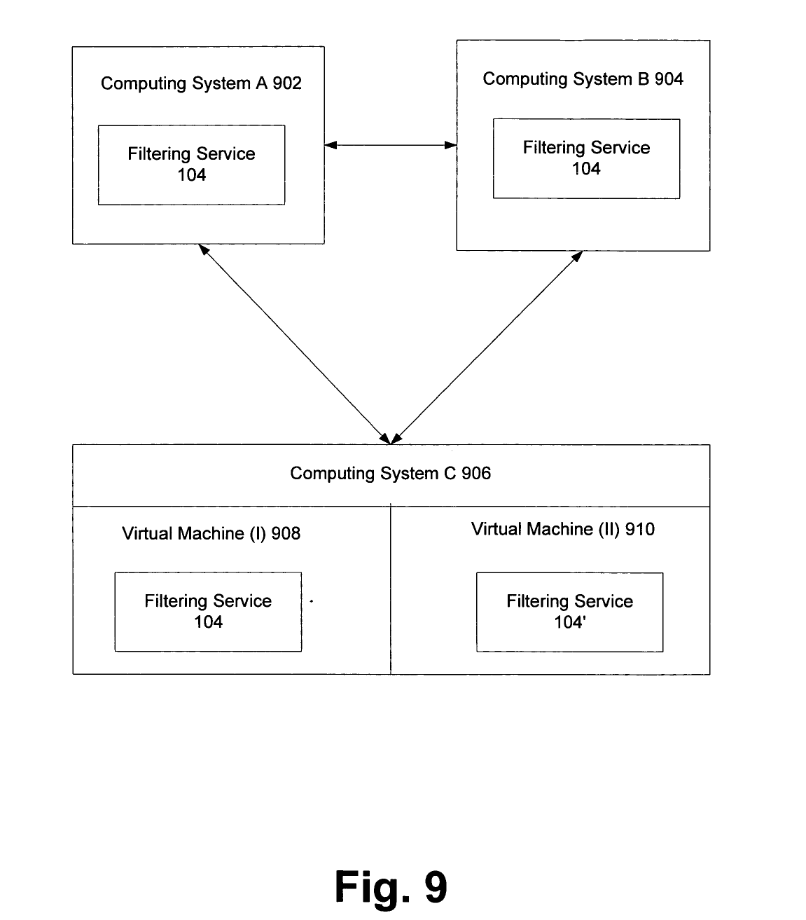

This Detailed Description is divided into three parts. In the first part, corresponding to FIGS. 1-3B, the architectural aspects of internet content filtering are provided. Then, in the second part, corresponding to FIGS. 4-7, certain visual aspects are provided, for example, illustrating various windows. Lastly, in the third part, corresponding to FIGS. 8-9, sample implementations are discussed.

I. Architectural Aspects of Internet Content Filtering

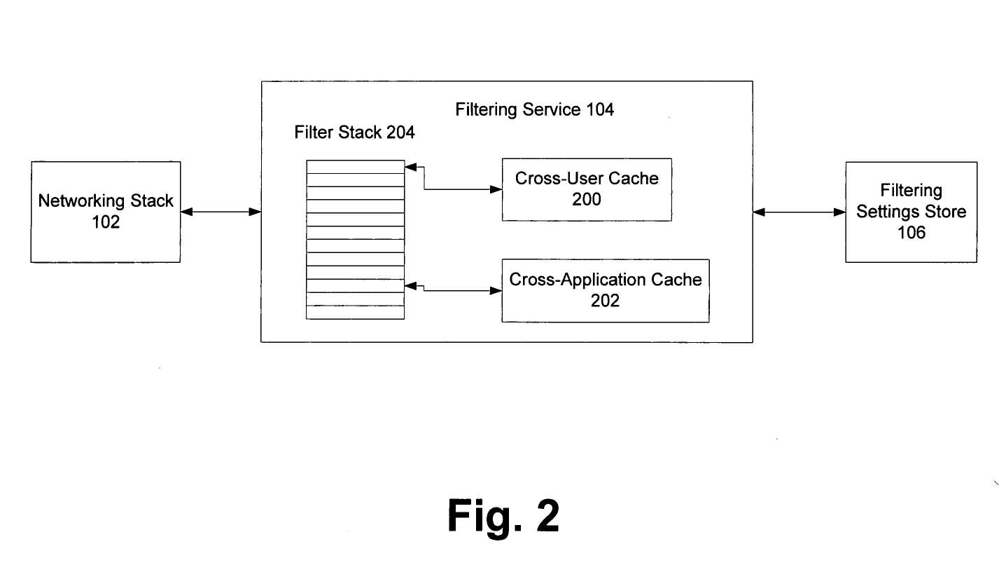

FIG. 1 illustrates an architecture for one exemplary implementation of the presently disclosed subject matter. The focus of the presently disclosed subject matter is a filtering service 104 located at the center of this architecture. The filtering service 104, described in more detail with reference to FIG. 2, can interact with various components and modules. Advantageously, it can be a centralized internet filtering service for any operating system and it can tightly integrate with such an operating system.

For example, the filtering service 104 can make policy judgments that a networking stack 102 can then enforce (the inner workings of the networking stack 102 are described in more detail in one of the related applications listed above). Thus, the networking stack 102 allows for a computing system on which it (and the filtering service 104) subsist, to communicate 154 via the internet 103 with some remote computing devices 105. Such communications 154 are monitored by the networking stack 102 and modified, if need be. Interestingly, judgments as to what modify and how to modify such communications 154 can be made by the filtering service 104. The networking stack 102 can ask 130 the filtering service 104 to make policy decisions, and the filtering service 104 can in turn provide 130 the networking stack 102 with instructions, so that the networking stack 102 can implement or execute those instructions.

The filtering service 104 can not only make the aforementioned policy judgments based on its own stored policy decision which may persist in a persistence store or in a filtering settings store 106, but it can also obtain 152 them from a remote service, such a website ratings service 107 that provides policy judgments regarding what ratings content should have (other policy services, of course, can also be contacted, and this is merely an exemplary service 107). Thus, the filtering service 104 can contact 132 the filtering settings store 106 in order to inquire what policy judgments may be relevant to some communications 154 with external or remote computing devices 105 or services. Moreover, the filtering settings store 106 can contain information such as when filtering should be on or off (for particular users and applications, system-wide), when certain events should be logged nor not logged, and which web sites should be accessible and which should be blocked.

The filtering service 104 may also communicate 134 with a logging service 108 that may log any communications a user is engaging in via some applications that are subject to the filtering service's 104 supervision—or at least those applications and programs that are installed on the same computing system as the filtering service 104. Logging can include, but is certainly not limited to, recording which URLs a user either has visited or has attempted to visit. Thus, in one aspect of the presently disclosed subject matter, the filtering service 104 can write web events to the logging service 108, via some API, for example, and it can also write any system events to the logging service 108.

Various other components can communicate with the filtering service 104, whether directly or indirectly. For instance, an administrative override application 114 can override certain blocked URLs to unblock them—or vice versa, to block unblocked URLs. The administrative override application 114 can communicate 144 with the above mentioned logging service 108, to write override events. It can also communicate 142 with and override contents of the filtering settings store 106, such as to set particular user settings. Lastly, it can directly access 146 the filtering service 104 in order to retrieve override request details.

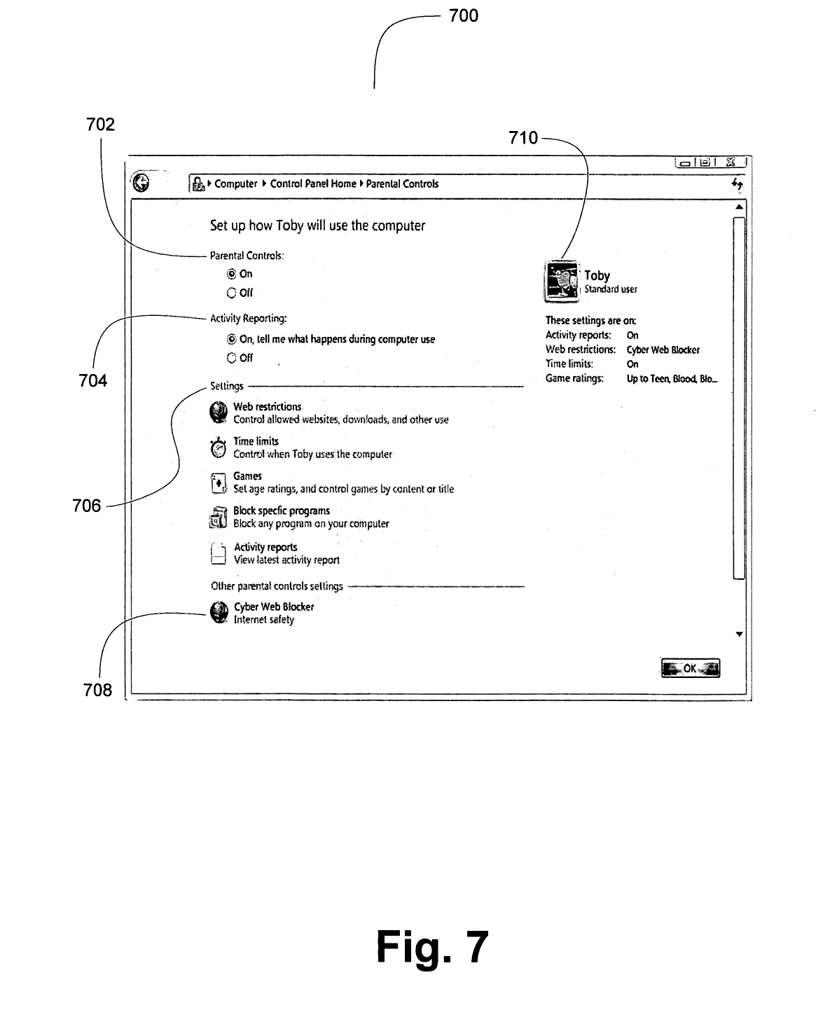

Another component that the filtering service 104 may communicate 140 with, albeit indirectly in the disclosed architecture of FIG. 1, is the control panel 112. Administrators, parents, or any users wanting to employ the filtering service 104 can set filtering policies for the filtering service 104 to consider, so that it can then access 132 these policies from the filtering settings store 106 in order to provide 130 the appropriate instructions for the networking stack 102 to implement. The control panel 112 can be implemented in various forms, and two such forms are illustrated in FIGS. 4 and 7 and accompanied with a discussion below.

Other components, such as an application 118 and some web restriction program 116 can request 150 and 148, respectively, that certain events be overridden in the filtering settings store 106. The Application 118 can be any application on a computing system, such as e-mail, web browser, instant messaging, and so on; the web restriction program 116 can be any override executable. As indicated above, the application 118 can directly communicate 151 with the networking stack 102—for example, anytime the application 118 either receives or sends content via the internet 103. Furthermore, the application 118 can communicate 153 with the web restriction program 116 in order to request override indirectly via an embedded link in an error page.

Lastly, an activity report viewer 110 can access 138 the filtering settings store 106 in order to get user settings. Likewise, it can access 136 the logging service 108 to read activity logs. The purpose of discussing the components of FIG. 1 (which could be modules or elements, and the like), is to demonstrated the rich and integrated environment in which the filtering service 104 operates. In other words, it is to provide a context for the filtering service 104.

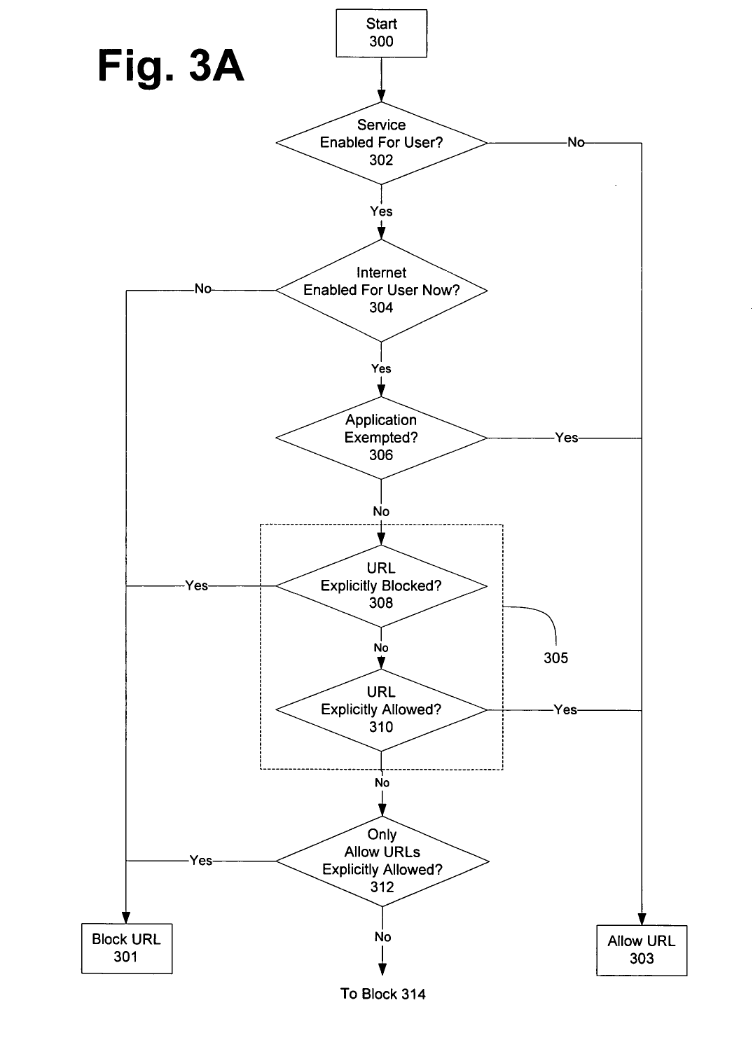

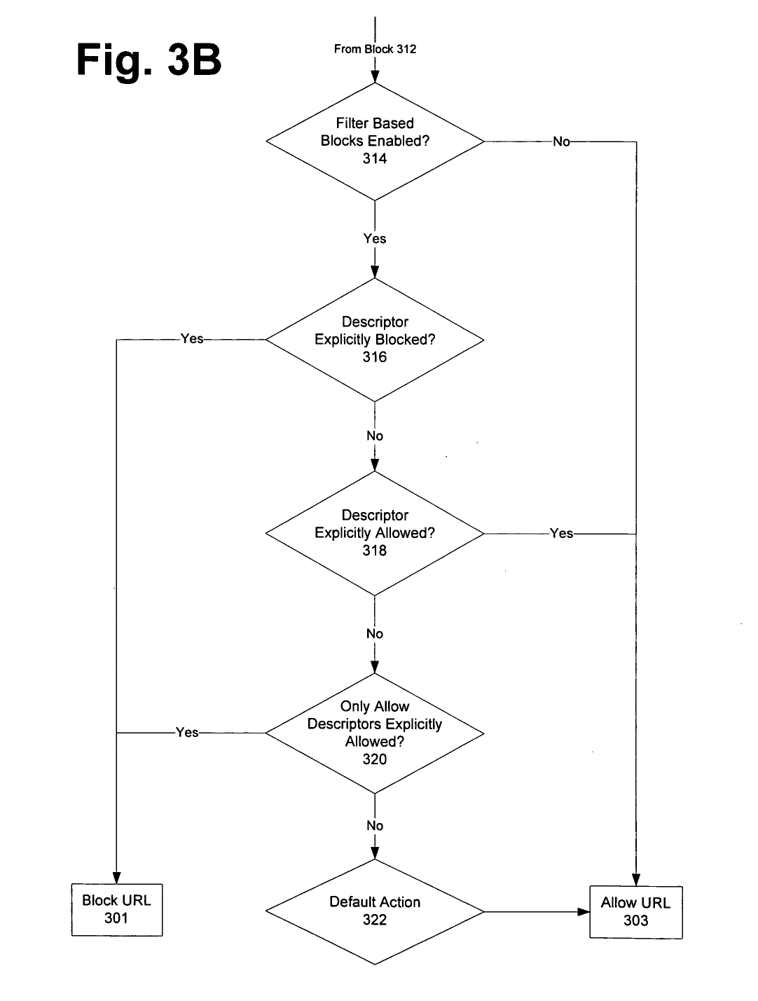

FIG. 2, thus, provides a detailed discussion of the filtering service 104 itself. In one aspect of the presently disclosed subject matter, the filtering service 104 may comprise of a filter stack 204, a first cache, such as a cross-user cache 200, and a second cache, such as a cross-application cache 202 (a detailed discussion regarding the filter stack 204 is provided with reference to FIG. 3). The filter stack 204 may access either one (or both) of these caches as it executes objects (which may contain code and/or data). During any time the filter stack 204 is executing objects, these caches 200 and 202 may provide useful information to the filtering stack 204 so that it may produce policy results regarding whether a stream of data (or even a portion of that stream of data) should be allowed to enter a computing system or leave a computing system, i.e., whether incoming data streams should be able to be downloaded by applications running on the computing system or whether outgoing data streams leaving the applications should be able to be uploaded to some remote computing systems.

Thus, in one aspect of the presently disclosed subject matter, a computing system containing such a filtering service 104 is provided, where the filtering service 104 is used in the computing system for filtering the traffic of content associated with the system. In broad terms, a first cache 200 for storing a first resource can be provided, where the first cache 200 is configured to be accessed for data applicable to at least one user. This means that data for a first user, such as Toby, may be stored in the cross-user cache 200 and this data may be further accessed at a later time by a second user, say, Suzy. Thus, the cross-user cache 200 may provide data sharing and leveraging for multiple users.

Next, a second cache 202 for storing a second resource can be provided, where the second cache 202 is configured to be accessed for data applicable to at least one application. This in turn, allows for different applications to access the same cache 202. An e-mailing application and a browser can use this cache 202 in order to ultimately obtain judgments whether some stream of data should be filtered or not. Moreover, this cache 202 may not only be used by different kinds of applications but also different applications of the same kind, say, two web browsers manufactured by two different parties.

Since the filter stack 204 may be configured to access either one the caches 200 and 202 in order to filter content based on the first resource and the second resource, respectively, it provides a more efficient framework for filtering, since the resources don't have to be downloaded from elsewhere (or looked up in lists), if the resources may be categories corresponding to URLs. The resources may, in one aspect, be descriptors of websites. They can categorize websites as violent, drug-based, sex-based, containing weapons, and so on. In one particular aspect, which is merely exemplary and not limiting, the filtering service 104 may filter content based on at least one of the following (or some combinations) of categories: alcohol, bomb-making, drugs, gambling, hate speech, mature content, pornography, sex education, tobacco, weapons, and so on. Interestingly enough, such categorization may also extend to the type of application that is being used, whether web-email, web-chat, or other such programs.

The filtering service 104 is flexible enough to filter in a variety of ways, whether the filtering is level-based or type-based or anything else. In the former case, level-based filtering may include having a low level, a medium level, and a high level of scrutiny for the type of content that a data stream may contain. In the latter case, type-based filtering may include aged-based filtering (for example, not allowing access to the internet for kids under the age of 10) or list-based filtering (for example, not allowing access to specific websites that appear somewhere on a “black list”).

Moreover, the content filtering by the filtering service can be based on web restrictions, time limits, ratings, program-type and/or personal controls. For example, certain web sites can be outright restricted; some users may have time limits as to how long they may use a computing system-or between what hours a computing system may be used; certain programs, such as games, can also be rated and thus restricted if the rating does not square with policy decisions accessed from a filtering settings store 106; certain programs may be restricted, such as instant messaging, if a parent, for instance, sees a child spends too much time using this program; and lastly, settings may have particularized controls in place that use a combination of these restrictions and other restrictions that may be implemented by a parent or some administrator of the computing system.

Furthermore, as can be seen in FIG. 2, the filtering service 104 can be configured to provide content-based instructions to a system for carrying out those instructions, such as the networking stack 102. The filtering service 104 can also be configured to access a settings store 106 in order to obtain at least one of the first and second resources mentioned above.

Furthermore, as in clear from FIG. 1, the filtering service can be configured to be overridden by an override application 114. Also, it can be configured to provide events to a logging service 108. And lastly, the filtering service can accesses remote data from a remote source, such as a website rating service 107.

Next, FIGS. 3A and 3B illustrate in block diagram form a typical execution path for the filter stack 204 discussed with reference to FIG. 2. FIG. 3A starts off this path and FIG. 3B completes the path. Thus, in FIG. 3A, a filter stack may start 300 by popping off the first set of instructions. For example, at block 302, the filtering stack may inquire into whether the filtering service 104 (as mentioned with reference to FIG. 1) is enabled for a user. If it is not enabled, any URL accessed by the user is explicitly allowed. In other words, the default position may be that if the service 104 is not turned on for a user, that user may access the internet and any URLs as if the service 104 were not there. Of course, this default set-up is merely implementation specific, and those of skill in the art can easily appreciate the opposite scenario, where the default position is block URLs for users for whom the service has not been enabled.

If at block 302 the answer is that, yes, the service is enabled for the user, then the stack inquires, at block 304, whether the internet is now enabled for the user. If at block 304, the internet is not enabled for the user, any inbound or outbound URL will be blocked. If the answer is yes, the stack filter asks whether the application the user is using is exempted from filtering—i.e. whether it is on an exemption list. If it is on such a list, URLs are allowed. If, on the other hand, the application is not exempted, the stack filter continues on to block 308.

At block 308, the filter stack has to decide whether a given URL is explicitly blocked. If it is, then the URL is not allowed to reach a user's application. If it is not, at block 310, a determination is made whether it is explicitly allowed. If it is explicitly allowed, the URL is able to reach the user's application.

At block 312, a determination can be made as to whether only URLs explicitly allowed should be allowed. If only explicitly allowed URLs are allowed, any URL that was not explicitly allowed will be blocked. Otherwise, it will be allowed barring any other rules explicitly blocking it.

Next, in FIG. 3B, at block 314, the filter stack makes a determination as to whether filter based blocks are enabled. If the answer is no, the URL will be allowed. In other words, if a descriptor or category based filtering is not enabled, the URL will be allowed. Conversely, if the answer is yes, another determination can be made at block 316.

At block 316, a determination is made as to whether URLs contain descriptors or categories that are explicitly blocked. If so, the URLs are blocked. However, if this is not the case, at block 318, a determination is made whether URLs contain descriptors or categories that are explicitly allowed. If so, the URLs are allowed. If that is not the case, then another determination is made at block 320.

At block 320, a determination is made as to whether only descriptors explicitly allowed should be allowed (or whether, potentially, others could be allowed also). If the answer is yes, than any URLs having passed on so far will be blocked. Otherwise, if the answer is no, the filter stack will go on to block 322 and by default allow any URLs that have passed through the crucible of blocks 300-320.

II. Visual Aspects of Internet Content Filtering

In addition to the architectural aspects of the presently disclosed subject matter, there are numerous visual aspects, of which, a few are presented in this section, merely by example, however, and not limitation. In FIG. 4, for example, a parental controls interface 400 is depicted. The interface 400 can set filtering settings for some individual (“Toby” in FIG. 4) or application.

The first question 402 that the interface might present to user or administrator is whether the individual wants to block some web content. Next, a second question 404 can be asked that concerns the filtering of web content. This second question 404 might want input regarding the restriction level of the filtering to be performed. For example, one restriction level might allow only websites on an allowed websites list; another restriction level might allow kids websites only; yet another might provide a generic medium restriction; still another may provide a low restriction; finally, the interface 400 might allow for a custom restriction to be made by the individual.

The third question 406 the interface 400 might present may concern the type of content (or the category of content or the description of content). For example, any URLs that display in any form blocked content will not be accessible to “Toby”. Per FIG. 4, this may include content containing: Alcohol, Bomb making, Drugs, Gambling, Hate Speech, Mature content, Pornography, Sex education, Tobacco, Weapons, Web-email, Web chat, etc. Thus, not only can content be blocked that is displayed in one type of application, such as drugs displayed in a web browser, but also drug references in web e-mail or web chat programs.

Lastly, as a catch-all option 408, websites that cannot be rated for some reasons may be blocked by default. This interface 400 can provide numerous other inputs to individuals wishing to filter web content. If the user is a developer, the interface could even be reconfigured to provide access to functionalities discussed in other parts of the presently disclosed subject matter, as for example, the subject matter referencing FIGS. 1, 2, 3A, and 3B.

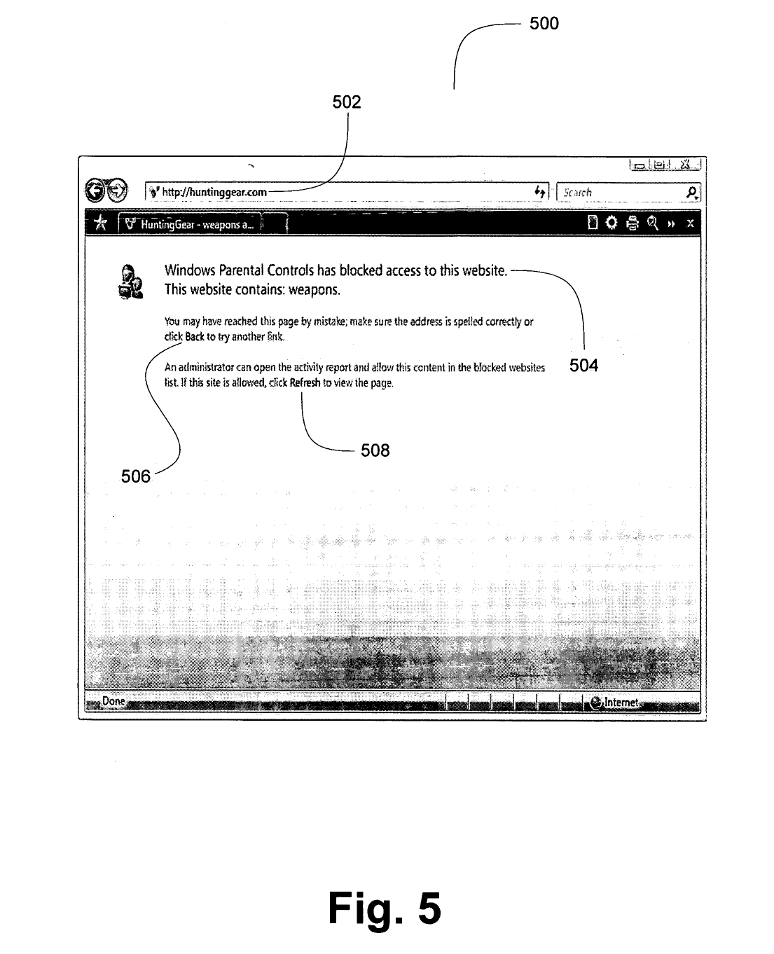

Next, FIG. 5 illustrates what happens when a user, such as “Toby” above, attempts to access a URL that has been blocked based on one of the reasons discussed above. A window 500 is displayed, and the site 502 Toby tried to access, http://huntinggear.com is blocked. Instead, the window 500 displays a message 504: “Windows Parental Control has blocked access to this website. This website contains: weapons.” The message 504, of course, could be displayed for any operating system, not just the Windows operating system, and the reason for blocking a website could be multifold—weapons, alcohol, bomb making, etc—not just weapons.

In addition, the window 500 can display a mechanism 506 to get back to some other page via a link. Also, the window 500 can allow the user to retry entering the website 502 again, if after consultation with an administrator or a parent, the user received permission to enter the site 502. Thus, the user might refresh 508 the window 500 in order enter the site 502. Furthermore, a request can be made by a user to override a blocked window via a link (not illustrated) which may be embedded in the window 500.

In order to support this functionality, an API can be provided to request permission to view a blocked page. Browsers can call this API to start a process where a user can request access. For example, the following code might be implemented to this end:

```
      // Create the root WPC object
      CComPtr<IWindowsParentalControls> spiWPC = NULL;
      HRESULT hr =
      spiWPC.CoCreateInstance(_uuidof(WindowsParentalControls));
      if (SUCCEEDED(hr))
      {
        // Retrieve the Web settings object for our user SID
        CComPtr<IWPCWebSettings> spiWeb;
        hr = spiWPC->GetWebSettings(m_pcszSID, &spiWeb);
        if (SUCCEEDED(hr))
        {
              // Request the URL override for our
single URL (we could also include
                sub-URLs if needed)
              BOOL fChanged;
              hr = spiWPC->RequestURLOverride(pcszURL,
0, NULL, &fChanged);
        }
      }
```

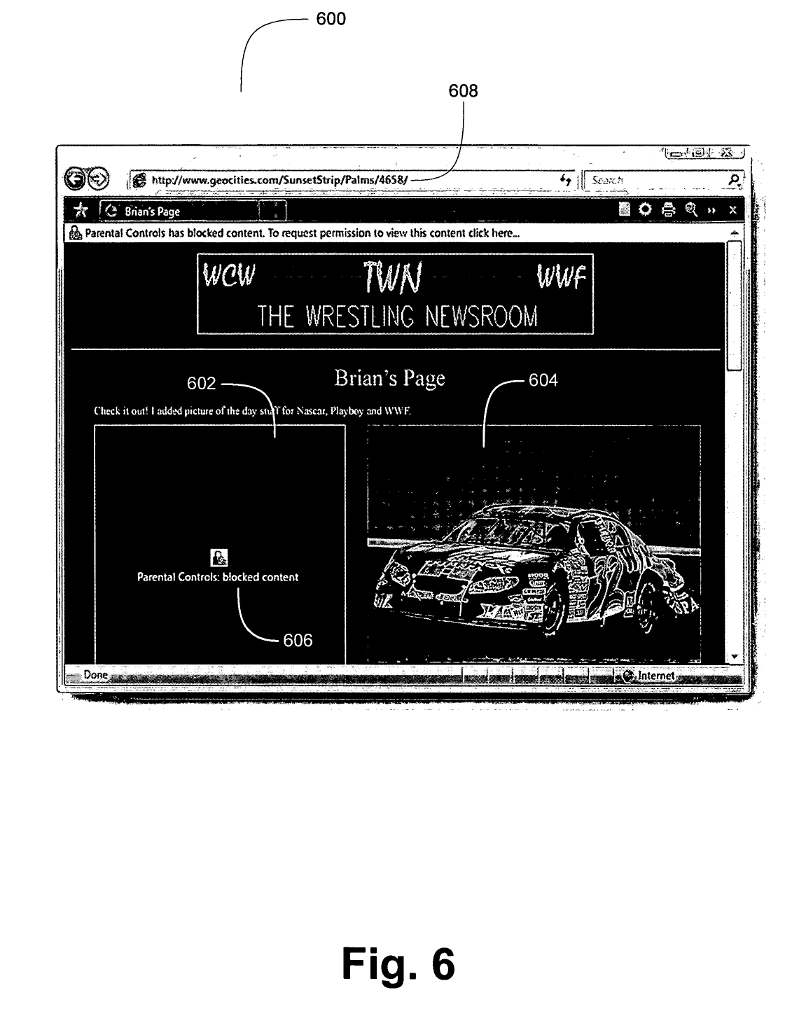

Next, FIG. 6 illustrates that the filtering service can make judgments not only whether an entire URL should be blocked, but rather which portions of an associated website should be blocked. Thus, for example, individual parts of a web page can be blocked, whether images, script, controls, etc. Upon accessing a website 608, a user may have some of the content blocked 602 and some of it not blocked 604. The window 600 can specify which part was blocked 602 by displaying a message 606, such as “Parental Control: blocked content.” Any other content that passes through 604 the filtering service, can be displayed in its usual manner. Those skilled in the art will readily appreciate the various content identifying techniques, whether text-based, code-based, or picture-based, that can be used to identify content (and then to potentially block it).

In another aspect of the presently disclosed subject matter, FIG. 7 illustrates how parental controls may be set up by some administrator or parent. A parental controls window 700 can be set up for a particular user 710 (such as “Toby”). The parental controls can be explicitly turned on or off 702. Also, any activity that Toby generates with any applications, whether web browsers, e-mail, instant messaging, etc., may be reported 704 to the administrator or parent.

Moreover, various settings 706 may be stipulated. For example, web restrictions may be set to control allowed websites, downloads, and other such uses. Time limits can be set, in order to control the times when a user can use a computer. For example, Toby's parents can set computer use between 5 p.m. and 9 p.m., corresponding to the times when Toby should be doing his homework, between getting out of school and going to sleep, respectively.

Furthermore, the settings can include age ratings for games, in order to control the games by content or title. Such control of games may extend not only to games played locally on the computer the user is using, but also to online games. If a parent knows that some games are too violent, such games can be specifically blocked with another finctionality, such as “Block specific programs.” This, then, illustrates the idea that any of the settings may be set in any various combinations in order to obtain the most desired filtering mechanism.

Lastly, latest activities can be viewed by the administrator or parent. Such logging of activity was discussed with reference to FIG. 2. And, in addition, other parental controls settings 708 may be used in combination with the discussed settings 706.

III. Exemplary Implementations of Internet Content Filtering

Next, the filtering stack discussed in reference to FIGS. 2 and 3, can be implemented in a variety of ways. FIG. 8 illustrates one such exemplary but not limiting implementation. At block 800, a first step can be taken that comprises of receiving a request for making a judgment regarding a stream of content. This request can be sent from the networking stack 102 to the filtering service 104. It can be made per stream or per process, or just about per any designate unit of work.

Following this step, a second step can be taken, at block 802, that may comprise of the processing of the request using a filter stack, where the filter stack is configured to execute objects. This processing step can signal the beginning of execution of objects on the stack, at the stack starts popping off completed tasks or pushing on the stack of new objects.

At block 804 a third step can be taken that may include accessing at least one of a first cache and a second cache, where the fist cache is configured to store a first data applicable to at least one user and where the second cache is configured to store a second data applicable to at least one application. Such accessing of cross-user and cross-application data, as discussed above in reference to FIG. 2, may allow a computing system running the filtering service to leverage categorizations for certain information sources, for example, web sites, based on other users and other applications.

At block 806, a fourth step may comprise of using at least one of the first data and the second data while executing at least one of the objects. So, during the execution of whatever objects are stacked on the filtering stack, the filtering stack can reference either of these two caches for any identification of web sites with their status as allowed or not allowed based on the content of those web sites.

Of course, these four steps don't have appear in the order they are depicted in FIG. 8—nor are these essential steps, rather they are merely exemplary. Thus, other steps, based on the presently disclosed subject matter, could be imagined. For example, the four steps could further comprise of a fifth step, at block 810, of sending a response to the request, where the response includes information whether the stream of content should be allowed to either enter a computing system or exit a computing system.

Furthermore, a sixth step could be taken, at block 812, that may comprise of accessing a third data from a remote service in order to provide the third data to at least one of the first cache and the second cache. This accessing can be done in addition to the accessing of the filter settings store 106 that was discussed above. The remote service can be the website ratings service 107 illustrated in FIG. 1.

The steps taken so far have been cumulative in the sense that they may follow one another. However, some steps discussed so far can have specific implementations. For example, step 804 can be further implemented as block 804′, which provides for accessing at least one of the first cache and the second cache, is performed by the filtering service for one of a first user and at a later time for a second user, and for one of a first application and at a later time for a second application. As discussed above already, this step may allow for leveraging of stored information for one user by another user or for use of information stored for one application by another application.

Such steps could also be implemented in computer readable medium form. For example, a computer readable medium bearing tangible computer executable instructions could comprise of the steps of beginning to execute objects on a filtering stack, then accessing one of a first cache and a second cache at some point during the execution of the objects on the filtering stack, and finally making a determination based on the accessing of one of the first cache and the second cache whether at least a portion of a stream of data should be allowed to one of pass into a computing system and pass out of a computing system.

The making of the determination whether the at least portion of the stream of data should be allowed to one of pass into a computing system and pass out of a computing system could be provided as a result to a remote system, such as the networking stack 102. Furthermore, the making of the determination whether the at least portion of the stream of data should be allowed to either pass into a computing system or pass out of a computing system, could be based on remote data obtained from a remote source, such the ratings service 107 in FIG. 1. And last, at another step, upon obtaining the remote data, storing of the remote data could be done in at least one of the first cache and the second cache.

At last, FIG. 9 illustrates that the filtering service could be implemented in a variety of computing environments. For example, a filtering service 104 could be subsisting on some computing system A 902, but it could simultaneously via a networking connection be subsisting in a different computing system B 904 that may be running on a different physical machine. Alternatively (or additionally), the filtering service 104 could be subsisting on still another computing system C 906, and furthermore, within some virtual machine 908 of the computing system 906. Another, different filtering service 104′ could be running within another virtual machine 910. In short, the filtering service 104 could be implemented on a per operating system basis.

It should be noted that the various techniques described herein may be implemented in connection with hardware or software or, where appropriate, with a combination of both. Thus, the methods and systems of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present subject matter, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Lastly, while the present disclosure has been described in connection with the preferred aspects, as illustrated in the various figures, it is understood that other similar aspects may be used or modifications and additions may be made to the described aspects for performing the same finction of the present disclosure without deviating therefrom. For example, in various aspects of the disclosure, internet content filtering mechanisms were disclosed. However, other equivalent mechanisms to these described aspects are also contemplated by the teachings herein. Therefore, the present disclosure should not be limited to any single aspect, but rather construed in breadth and scope in accordance with the appended claims.

1. A computing system containing a filtering service for filtering content, comprising:
a first cache for storing a first resource, wherein the first cache is configured to be accessed for data applicable to at least one user;
a second cache for storing a second resource, wherein the second cache is configured to be accessed for data applicable to at least one application; and
a filter stack configured to access at least one of the first cache and the second cache in order to filter content based on at least one of the first resource and the second resource.

2. The system according to claim 1, wherein at least one of the first resource and the second resource comprises of a descriptor for a particular web site.

3. The system according to claim 2, wherein the descriptor comprises a categorization of the particular web site.

4. The system according to claim 3, wherein the categorization includes at least one of alcohol, bomb-making, drugs, gambling, hate speech, mature content, pornography, sex education, tobacco, weapons, web-email, and web-chat.

5. The system according to claim 1, wherein the content filtering by the filtering service is one of level-based and type-based filtering.

6. The system according to claim 5, wherein the level-based filtering includes at least one of a low level, a medium level, and a high level, and wherein the type-based filtering includes at least one of aged-based filtering and list-based filtering.

7. The system according to claim 1, wherein the content filtering by the filtering service is based on one of web restrictions, time limits, ratings, program-type and personal controls.

8. The system according to claim 1, wherein the filtering service is configured to provide content-based instructions to a system for carrying out those instructions.

9. The system according to claim 1, wherein the filtering service is configured to access a settings store in order to obtain at least one of the first resource and the second resource.

10. The system according to claim 1, wherein the filtering service is configured to be overridden by an override application.

11. The system according to claim 1, wherein the filtering service is configured to provide events to a logging service.

12. The system according to claim 1, wherein the filtering service accesses a remote data from a remote source, wherein the remote data is in a format to be stored in at least one of the first cache and the second cache.

13. A method for filtering content accessible on a computing system, wherein the filtering is performed with the aid of a filtering service, comprising:
receiving a request for making a judgment regarding a stream of content;
processing the request using a filter stack, wherein the filter stack is configured to execute objects;
accessing at least one of a first cache and a second cache, wherein the fist cache is configured to store a first data applicable to at least one user and wherein the second cache is configured to store a second data applicable to at least one application; and
using at least one of the first data and the second data while executing at least one of the objects.

14. The method according to claim 13, further comprising sending a response to the request, wherein the response includes information whether the stream of content should be allowed to one of enter a computing system and exit a computing system.

15. The method according to claim 13, further comprising accessing a third data from a remote service in order to provide the third data to at least one of the first cache and the second cache.

16. The method according to claim 12, wherein accessing at least one of the first cache and the second cache is performed by the filtering service for one of a first user and at a later time for a second user, and for one of a first application and at a later time for a second application.

17. A computer readable medium bearing tangible computer executable instructions, comprising:
beginning to execute objects on a filtering stack;
accessing one of a first cache and a second cache at some point during the execution of the objects on the filtering stack; and
making a determination based on the accessing of one of the first cache and the second cache whether at least a portion of a stream of data should be allowed to one of pass into a computing system and pass out of a computing system.

18. The computer readable medium according to claim 17, wherein upon making the determination whether the at least portion of the stream of data should be allowed to one of pass into a computing system and pass out of a computing system, providing a result to a remote system.

19. The computer readable medium according to claim 17, wherein making the determination whether the at least portion of the stream of data should be allowed to one of pass into a computing system and pass out of a computing system, is based on remote data obtained from a remote source.

20. The computer readable medium according to claim 19, upon obtaining the remote data, storing the remote data in at least one of the first cache and the second cache.
